(19) United States
(12) Patent Application Publication
(10) Pub. No.: US 2023/0418167 A1
(43) Pub. Date: Dec. 28, 2023

(54) METHOD AND SYSTEM FOR CLEANING OPTICAL ELEMENTS IN EUV OPTICAL SYSTEMS

(71) Applicant: KLA Corporation, Milpitas, CA (US)

(72) Inventors: Yun Xie, Milpitas, CA (US); Rui-Fang Shi, Cupertino, CA (US); Shannon Hill, Milpitas, CA (US)

(21) Appl. No.: 17/944,009

(22) Filed: Sep. 13, 2022

Related U.S. Application Data
(60) Provisional application No. 63/356,035, filed on Jun. 28, 2022.

(51) Int. Cl. G03F 7/20; G06F 30/10

(52) U.S. Cl. CPC G03F 7/70533; G03F 7/70033; G03F 7/70925; G06F 30/10; G06F 2113/10

(57) ABSTRACT

A system and method for cleaning an optical element of an EUV optical system is disclosed. The system and method may include receiving design data of one or more samples. The system and method may include simulating a plurality of irradiance distributions at a plane of an EUV optical sub-system based on the design data and one or more parameters. The system and method may include aggregating the plurality of irradiance distributions to generate an aggregated irradiance distribution. The system and method may include determining a predicted contaminate distribution based on both the aggregated irradiance distribution and a contaminate growth rate. The system and method may include determining a cleaning recipe for the one or more optical elements based on the predicted contaminate distribution.

### CROSS-REFERENCE TO RELATED APPLICATION

The present application claims the benefit under 35 U.S.C. § 119(e) of U.S. Provisional Application Ser. No. 63/356,035 filed on Jun. 28, 2022, which is incorporated herein by reference in the entirety.

### TECHNICAL FIELD

The present disclosure relates generally to extreme ultraviolet characterization systems and, more particularly, to cleaning optical elements of extreme ultraviolet characterization systems.

### BACKGROUND

As the demand for lithography-based device structures having ever-smaller features continues to increase, the need for improved illumination sources used for lithography and inspection of the associated reticles that lithographically print these ever-shrinking devices continues to grow. One such illumination source, utilized in lithography and inspection systems, is an extreme ultraviolet (EUV) light source.

In an inspection system using EUV, maintaining the environment cleanliness is crucial to sustaining the mirror reflectivity and the overall EUV photon budget. However, contaminants that tend to foul the vacuum environment cannot be completely removed from the system. Such is the case, for example, when components of the EUV system, such as adhesives, actuators, and cables, contain unavoidable contamination sources. As a result, the EUV optics, within the vacuum chamber, are exposed to a partial pressure of contaminants, such as hydrocarbons and gas phase H₂O. These contaminants, when exposed to the EUV radiation within the tool, will lead to the growth of carbon and/or oxides on optical surfaces of the system, such as mirrors. In the case of mirrors, the contamination will cause a reflectivity drop and a phase change in the light incident upon the mirror. Both of these effects, if unchecked, will cause a degradation of the optics over time, leading to a failure of the optical system.

Even with the best multi-layer coating technology, each EUV mirror at normal or near normal incidence angle will likely only reflect about 65% of the light. This reflectivity will be lowered by carbon deposition on the optic surfaces caused by the interaction of volatile organic contamination (VOC) with the energetic EUV photons as well as other wavelengths. For example, in an EUV system, vacuum-ultraviolet/ultraviolet (VUV/UV) photons with wavelengths below 300 nm may also be present in the imaging light and cause contaminate deposition.

The contaminate growth rate is proportional to the total EUV and VUV/UV irradiance up to a certain threshold irradiance, above which the growth rate is independent of irradiance. For mirrors that are irradiated nonuniformly, the carbon growth rate will be dose dependent in regions with irradiance below this threshold, while the growth rate will be uniform and dose-independent in regions with irradiance above the threshold. Consequently, if the mirror is near the pupil plane of an imaging system, this nonuniform carbon growth will increase the wave front error as well as lower reflectivity.

Some methods of cleaning deposited carbon include exposure of a mirror surface to UV light in the presence of ozone molecules (UVO). The carbon removal rate is generally proportional to the UV irradiance. Typically, the mirrors are uniformly irradiated with the UV light. Under such conditions, some areas of an optic element with non-uniform carbon deposition will be overcleaned to ensure the area with the highest levels of carbon deposits are fully cleaned. This can result in longer cleaning time than is necessary for areas with low carbon deposits and perhaps cause damage to the mirror surface from over-cleaning.

Therefore, it is desirable to provide a method and system for cleaning optical elements to cure the above deficiencies.

### SUMMARY

An EUV optical system is disclosed, in accordance with one or more embodiments of the present disclosure. In one illustrative embodiment, the EUV optical system includes an EUV optical sub-system configured for cleaning an optical element of the EUV optical system. In one illustrative embodiment, the EUV optical sub-system includes a controller communicatively coupled to EUV optical sub-system. In another illustrative embodiment, the controller includes one or more processors and may include memory. In another illustrative embodiment, the one or more processors are configured to execute a set of program instructions stored on the memory. In another illustrative embodiment, the one or more processors are configured to execute program instructions causing the one or more processors to receive design data of one or more samples. In another illustrative embodiment, the one or more processors are configured to execute program instructions causing the one or more processors to simulate a plurality of irradiance distributions at a plane of the EUV optical sub-system based on the design data and one or more parameters. In another illustrative embodiment, the one or more processors are configured to execute program instructions causing the one or more processors to aggregate the plurality of irradiance distributions to generate an aggregated irradiance distribution. In another illustrative embodiment, the one or more processors are configured to execute program instructions causing the one or more processors to determine a predicted contaminate distribution based on both the aggregated irradiance distribution and a contaminate growth rate, where the contaminate distribution is indicative of a predicted amount of contaminate deposited on the one or more optical elements. In another illustrative embodiment, the one or more processors are configured to execute program instructions causing the one or more processors to determine a cleaning recipe for the one or more optical elements based on the predicted contaminate distribution, where the cleaning recipe comprises one or more cleaning processes.

A method is disclosed, in accordance with one or more embodiments of the present disclosure. In one illustrative embodiment, the method may include, but is not limited to, receiving design data of one or more samples. In another illustrative embodiment, the method may include simulating a plurality of irradiance distributions at a plane of an EUV optical sub-system based on the design data and one or more parameters. In another illustrative embodiment, the method may include aggregating the plurality of irradiance distributions to generate an aggregated irradiance distribution. In another illustrative embodiment, the method may include determining a predicted contaminate distribution based on both the aggregated irradiance distribution and a contaminate growth rate, where the contaminate distribution is indicative of a predicted amount of contaminate deposited on one or more optical elements of the EUV optical sub-system. In another illustrative embodiment, the method may include determining a cleaning recipe for the one or more optical elements based on the predicted contaminate distribution, wherein the cleaning recipe comprises one or more cleaning processes. In another illustrative embodiment, the method may be performed via an EUV optical sub-system including an illumination source configured to generate an illumination beam; and the one or more optical elements configured to reflect a measurement beam, where the one or more optical elements are located in a collection pathway of the EUV optical sub-system, wherein an EUV optical system includes the EUV optical sub-system.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 is a simplified block diagram view of an EUV optical system, in accordance with one or more embodiments of the present disclosure.

FIG. 2 is a flow diagram illustrating steps performed in a method, in accordance with one or more embodiments of the present disclosure.

FIG. 3A is a conceptual illustration of checkerboard photomask design data of a sample, in accordance with one or more embodiments of the present disclosure.

FIG. 3B is a conceptual illustration of complex photomask design data of a sample, in accordance with one or more embodiments of the present disclosure.

FIG. 4 is a plot illustrating normalized irradiance versus normalized carbon growth rate, in accordance with one or more embodiments of the present disclosure.

FIG. 5A is a schematic of an illumination pupil distribution of a circular illumination beam, in accordance with one or more embodiments of the present disclosure.

FIG. 5B are simulated collection pupil irradiance distributions of diffraction orders based on various incidence angle parameter values, in accordance with one or more embodiments of the present disclosure.

FIG. 5C is an aggregated irradiance distribution based on the simulated collection pupil irradiance distributions of FIG. 5B, in accordance with one or more embodiments of the present disclosure.

FIG. 5D is a predicted contaminate distribution based on the aggregated irradiance distribution, in accordance with one or more embodiments of the present disclosure.

FIG. 6A is a modulator configured for cleaning an inner region of an optical element, in accordance with one or more embodiments of the present disclosure.

FIG. 6B is a modulator configured for cleaning an outer region an optical element, in accordance with one or more embodiments of the present disclosure.

FIG. 6C is a fifth Zernike term far-field distribution for non-uniform cleaning, in accordance with one or more embodiments of the present disclosure.

FIG. 7 is a flow diagram illustrating a method for a two-part cleaning process of an optical element, in accordance with one or more embodiments of the present disclosure.

FIG. 8 is a flow diagram illustrating irradiance distributions for different wavelengths of light based on a dense pattern of design data, in accordance with one or more embodiments of the present disclosure.

FIG. 9 is a flow diagram illustrating irradiance distributions for different patterns of design data, in accordance with one or more embodiments of the present disclosure.

FIG. 10 is a flow diagram illustrating irradiance distributions for different patterns for a circular illumination beam of multiple samples as simulated in a field plane, in accordance with one or more embodiments of the present disclosure.

FIG. 11 is a flow diagram illustrating carbon distributions with and without an illumination chief-ray angle equal to an imaging illumination chief-ray angle, in accordance with one or more embodiments of the present disclosure.

FIG. 12 is a gaussian-shaped illumination beam and a carbon distribution based on the gaussian-shaped illumination beam, in accordance with one or more embodiments of the present disclosure.

FIG. 13A is a plot illustrating a normalized intensity of light of an EUV optical system, in accordance with one or more embodiments of the present disclosure.

FIG. 13B is a plot illustrating a normalized contaminate growth rate versus spectrum of light for a given intensity of irradiance, in accordance with one or more embodiments of the present disclosure.

FIG. 14 is a flow diagram illustrating a process for determining a carbon growth rate distribution based on EUV and VUV/UV light, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for performing a varying, location-specific cleaning of an optical element. For example, an aggregated irradiance distribution approximating a dose of irradiance received by an optical element of an EUV optical system may be determined by simulating and aggregating irradiance distributions received by the optical element during a scanning of one or more samples. In addition, a predicted contaminate distribution predicting an amount of contaminate thickness distributed upon the optical element may be determined based on the aggregated irradiance distribution. Further, a cleaning recipe may be determined based on such a predicted contaminate distribution using one or more modulators (e.g., apertures and the like) in one or more processing steps to clean the optical element. In this regard, a location-specific cleaning recipe may be determined based on a predicted contaminate distribution that efficiently cleans the optical element and reduces or eliminates over-cleaning, which, in some examples, may damage the surface of the optical element.

At least for carbon, the removal rate of the contaminate is generally proportional to the UV irradiance used to remove it.

One method of cleaning contaminates (e.g., carbon contaminates on a mirror of an EUV optical system) is to irradiate contaminates on the optical element with UV light in the presence of ozone, sometimes referred to as UV-Ozone (UVO) cleaning. In such methods, a uniform amount of UV light is often used to remove the contaminate regardless of the uniformity of the contaminate distribution on the surface. Under these conditions, some areas of the optical element having lower amounts of contaminate deposits are overcleaned to ensure the area with the highest levels of contaminates are fully cleaned. It is contemplated herein that such uniform cleaning may result in longer cleaning times and perhaps damage to the optical element due to overcleaning in regions with less contaminate deposits.

Another challenge of cleaning EUV optical elements is that the amount of contaminates may be hard to determine or measure. For example, optical elements of EUV systems are often in vacuum chambers and removing the optical elements for measuring a nano-meter scale thickness of contaminate deposits may be impractical and expensive. Therefore, without an accurate estimate of the highest level of contaminates, more excessive cleaning may be performed than is needed to ensure the areas with the highest level of contaminates are reduced to an acceptable level, further exacerbating the amount of overcleaning in areas with lower levels of contaminates.

While directly measuring the contaminate distribution on the optical element may be impractical, it is contemplated that the contaminate distribution may be determined and cleaned (e.g., precisely cleaned), by simulating irradiance distributions received by the optical element. Further, rather than performing uniform cleaning, embodiments may use location-specific cleaning via one or more light modulators to provide for specific doses of cleaning to specific areas of the optical element. Embodiments of the present disclosure determine the amount of contaminate distribution on the optical element and more precisely and efficiently clean the optical element. Additionally, embodiments may assist in reducing over-cleaning and damage to the optical element, improving clarity of measurements (e.g., images) obtained by using the optical element, and increasing measurement throughput of an actinic EUV optical system by reducing downtime needed for cleaning.

Such benefits may be especially apparent for optical elements located in a pupil plane of a collection pathway of the EUV optical system. For example, an optical element such as a mirror in or near the pupil plane of the collection pathway of the EUV optical system may receive irradiance distributions, that when aggregated, have values of higher variation (i.e., less uniformity) than aggregated irradiance distributions at other locations (e.g., field planes) of the EUV optical system. Such a higher variation is due to, at least in part, the location consistency of diffraction orders of light in pupil planes.

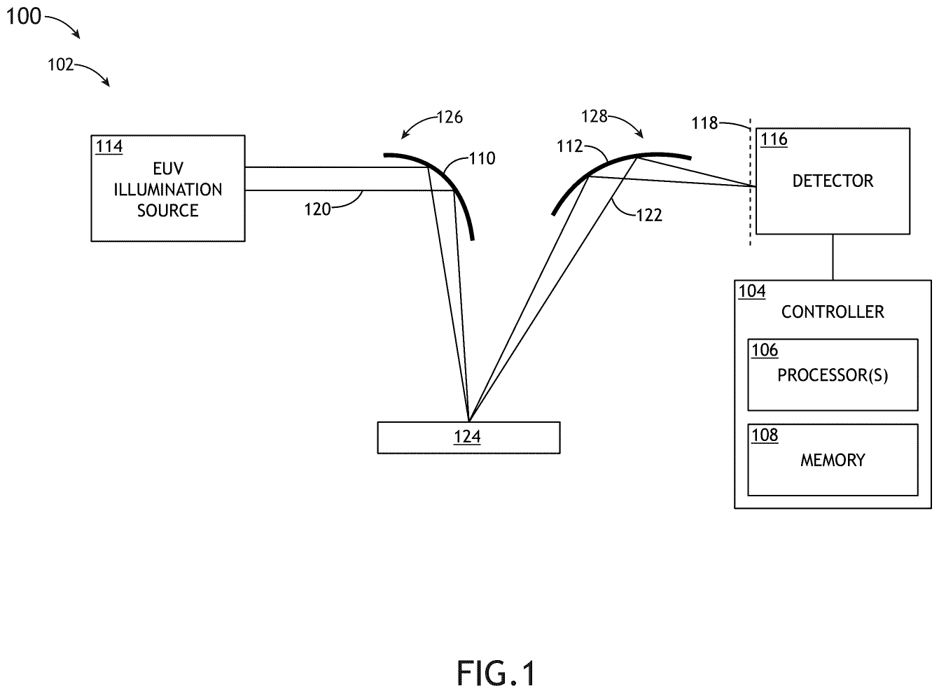

FIG. 1 illustrates a simplified block diagram view of an EUV optical system 100, in accordance with one or more embodiments of the present disclosure. In embodiments, the EUV optical system 100 includes an EUV inspection system (e.g., EUV mask inspection system or EUV wafer inspection system). In embodiments, the EUV optical system 100 includes an EUV lithography system.

In embodiments, the EUV optical system 100 includes an EUV optical sub-system 102 and controller 104. The controller 104 may include one or more processors 106 configured to execute program instructions maintained on memory 108. In embodiments, the one or more processors 106 are configured to execute program instructions causing the one or more processors to: i) receive design data of one or more samples 124; ii) simulate a set of irradiance distributions at a plane of the EUV optical sub-system 102 based on the design data and one or more parameters; iii) aggregate the set of irradiance distributions to generate an aggregated irradiance distribution; iv) determine a predicted contaminate distribution of a collection optical element 112 based on both the aggregated irradiance distribution and a contaminate growth rate; and v) determine a cleaning recipe for the collection optical element 112 based on the predicted contaminate distribution.

In embodiments, the EUV optical sub-system 102 includes an EUV illumination source 114 configured to generate an illumination beam 120 and direct the illumination beam 120 to the sample 124 via an illumination pathway 126 using one or more illumination optical elements 110. In embodiments, the EUV optical sub-system 102 includes a collection pathway 128 including one or more collection optical elements 112 configured to direct a measurement beam 122 emanating from the sample 124 to a detector 116.

EUV optical sub-system 102 may include any number of optical elements such as illumination optical elements 110 and collection optical elements 112. The one or more illumination optical elements 110 and one or more collection optical elements 112 may include any EUV optical element known in the art of EUV optics. For example, the one or more illumination optical elements 110 may include, but are not limited to, one or more EUV mirrors located in the illumination pathway 126 and configured to direct the illumination beam 120 to the sample 124. By way of another example, the one or more collection optical elements 112 may include, but are not limited to, one or more EUV mirrors located in the collection pathway 128 and configured to reflect the measurement beam 122 from the sample 124 to the detector 116.

Additionally, components and configurations of EUV optical systems may be better understood in regard to EUV systems described in U.S. Pat. No. 8,916,831, issued Dec. 23, 2014, which is hereby incorporated by reference in its entirety. Further, EUV systems are described in U.S. Pat. No. 11,293,880, issued Apr. 5, 2022, which is hereby incorporated by reference in its entirety.

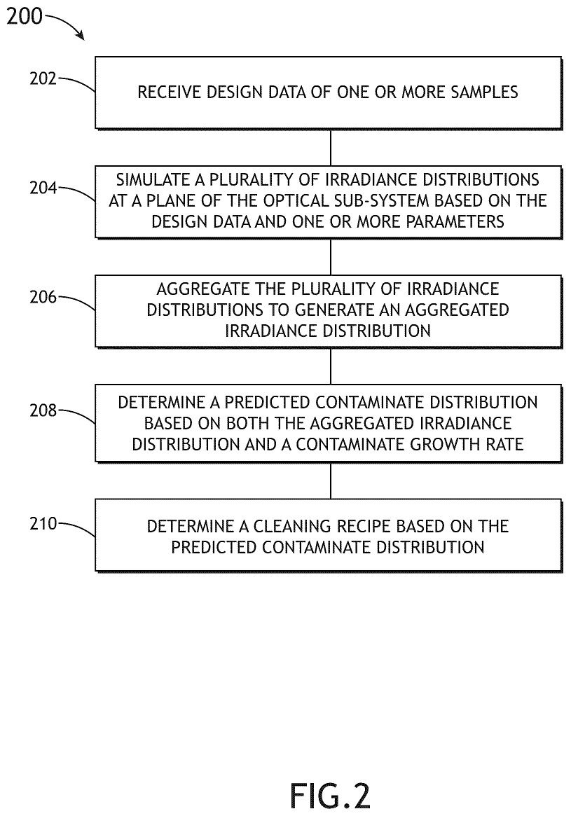

FIG. 2 illustrates a flow diagram of steps performed in a method 200, in accordance with one or more embodiments of the present disclosure.

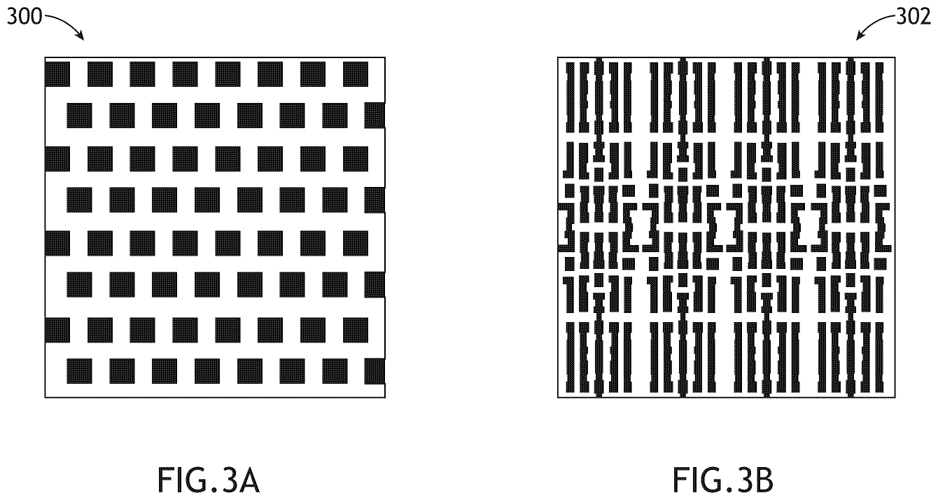

In a step 202, design data of one or more samples 124 is received. Design data may include any type of design data associated with a design of one or more layers of a sample 124. For example, FIGS. 3A and 3B are example conceptual illustrations of photomask design data 300, 302 including various patterns. In embodiments, the one or more processors 106 receive the design data from a design data database. For example, the design data database may include an off-system storage medium (e.g., server) or the design data database may be contained in memory 108 of EUV optical system 100.

In a step 204, a set of irradiance distributions at a plane of the EUV optical sub-system 102 are simulated based on the design data and one or more parameters. In embodiments, the set of irradiance distributions are simulated using a simulator on a processor. For example, the one or more processors 106 may be configured to execute program instructions of a simulator module (e.g., software, application) stored on memory 108 of the EUV optical system 100 and configured to simulate the set of irradiance distributions. In embodiments, referring back to FIG. 1, the set of irradiance distributions may be used to simulate (e.g., approximate) an amount of irradiance received by a collection optical element 112 based on one or more operations (e.g., imaging operations, lithography operations) of the EUV optical system 100. For example, multiple samples 124 may be imaged by the EUV optical system 100. In embodiments, patterns of a sample 124 create particular diffraction irradiance distributions at a collection pupil plane of the EUV optical system 100 when the sample 124 is illuminated. The irradiance distribution emanated from the samples and received by the collection optical element 112 of the EUV optical system 100 may be simulated based on the design of the samples 124.

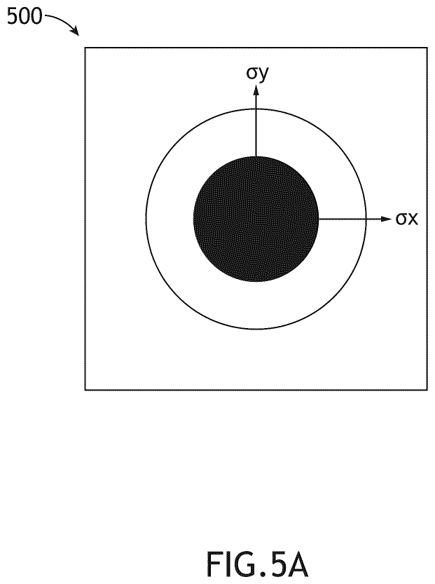

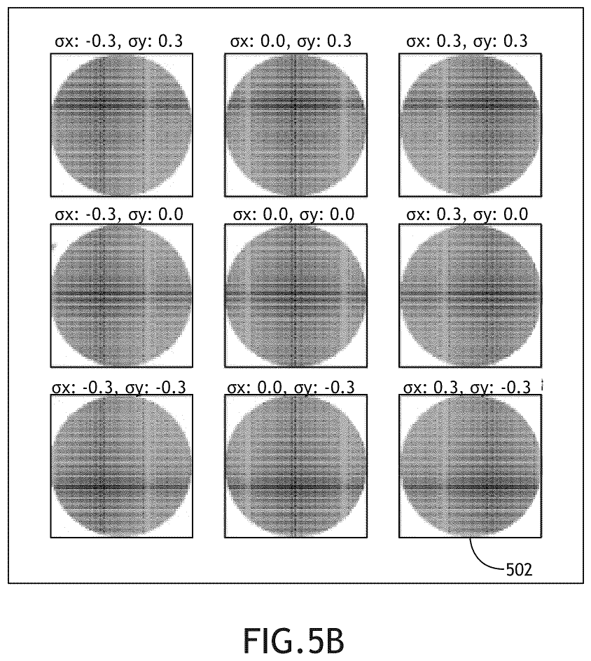

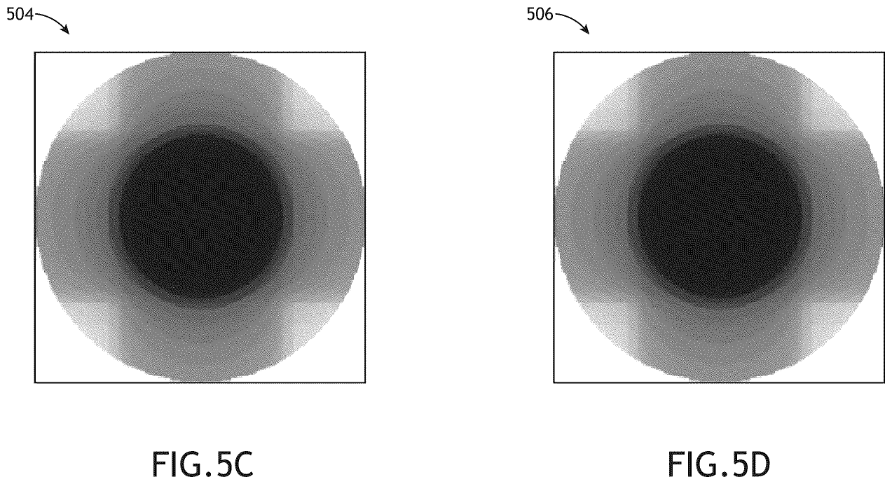

In embodiments, an irradiance distribution may be any type of irradiance distribution based on any type of simulation at any simulated location (e.g., plane) of an EUV optical system 100, using any values of any set of parameters. For example, various nonlimiting examples of irradiance distributions 502 are illustrated in FIG. 5B for nine different incidence angle values.

For purposes of the present disclosure, the term irradiance is the amount of energy per unit time that strikes a unit area, commonly referred to as the flux per unit area. Further, the term dose may be defined as irradiance multiplied by the dwell time. For at least some contaminants, the rate of growth/deposition of the contaminant is proportional, below a saturation threshold, to the dose received. However, it is noted that such a growth rate may also vary depending on the wavelength and other properties, which may also be simulated by embodiments.

In embodiments, the parameters may include any parameter that may be utilized in a simulation. For example, the parameters may, but are not required to, approximate real-world parameters of the EUV optical sub-system 102 and elements thereof. In embodiments, the parameters include, but are not limited to, incidence angles of an optical axis of light relative to a sample 124 illuminated by such a light, spectral ranges of light (e.g., the illumination spectrum based on a spectral range of light of the illumination beam), chief-ray angles, and the like. In addition, or alternatively, parameters may include various properties, characteristics, and arrangements of various optical elements. For instance, such parameters may include the optical properties (e.g., reflectivity, numerical aperture), material, size, shape, position, orientation, and/or the like of one or more elements. In addition, or alternatively, the parameters may include sample measuring recipe parameters. For example, parameters may include scanning pattern recipe parameters such as a size of a field of view of an area to be imaged or etched, scanning pass directions, overlap distances of scanning passes, and/or the like. In another example, parameters may include move-and-measure recipe parameters such as a size of a field of view, how long each field of view location will be illuminated for imaging purposes, which locations of a sample will be measured, and the like. Parameters may additionally or alternatively include a partial pressure and weight or volume percentages of VOCs surrounding the elements. Parameters may additionally or alternatively include simulation quality parameters such as how detailed the geometry of components are and which time-interval “size” the simulation is performed at. For example, the smaller the time-interval size, the more computation may be required to perform a simulation. For example, each irradiance distribution 502 may be based on where the sample 124 is located relative to an illumination beam at a given time, over a given time interval size (e.g., 1 nanosecond or less, 1 millisecond or less, 1 second or less, or any other time), for a given scanning speed (e.g., speed the sample is moved relative to the illumination beam). In this regard, the amount of irradiance received at a plane of a simulated EUV optical system 100 may be simulated over many different time intervals corresponding to many different locations of a sample 124 illuminated during a simulated scan of the sample 124. In this regard, the total dose of illumination received by an optical element during an entire measurement (e.g., entire scan) of one or more samples may be simulated.

In a step 206, the set of irradiance distributions are aggregated to generate an aggregated irradiance distribution. An aggregated irradiance distribution may be generated using any method disclosed herein or known in the art. In embodiments, the one or more processors 106 aggregate the set of irradiance distributions. For example, the one or more processors 106 may be configured to combine the set of irradiance distributions into an aggregated set of data and store such data on memory 108. By way of another example, the one or more processors 106 may be configured to determine a total summed irradiance distribution, average distribution, or any other type of calculated value based on a combination of the set of irradiance distributions. In embodiments, aggregating irradiance distributions 502 may allow for approximating the “dose” received by the collection optical element 112 during one or more scans of one or more samples 124 occurring over a period of time. A nonlimiting illustration of an aggregated irradiance distribution 504 is shown in FIG. 5C. In embodiments, the aggregated irradiance distribution 504 may include an aggregated extreme ultraviolet radiation (EUV) irradiance distribution corresponding to a simulated scan across the one or more samples 124 using light in the EUV spectral range.

In embodiments, while each irradiance distribution 502 may approximate the amount of irradiance directed to a plane of the EUV optical system 100 at a single point in time. Aggregating those irradiance distributions 502 may allow for approximating the total, combined “dose” received over a non-instantaneous period of time. For example, a simulation may be configured to simulate the dose received by a collection optical element 112 when scanning across patterns of a photomask based on an actual scanning pattern of the EUV optical system 100. In this regard, aggregating irradiance distributions 502 may allow for simulating the dose received based on such a scanning pattern.

In a step 208, a predicted contaminate distribution is determined. For example, a contaminate distribution may be determined (e.g., calculated) based on both an aggregated irradiance distribution of step 206 and a contaminate growth rate. In embodiments, the predicted contaminate distribution is determined by the one or more processors 106 and stored on memory 108. For instance, the predicted contaminate distribution may be indicative of a predicted amount of contaminate deposited on a surface of a collection optical element 112 based on a scanning of one or more samples 124. For example, an illustration of a predicted contaminate distribution 506 is shown in FIG. 5D.

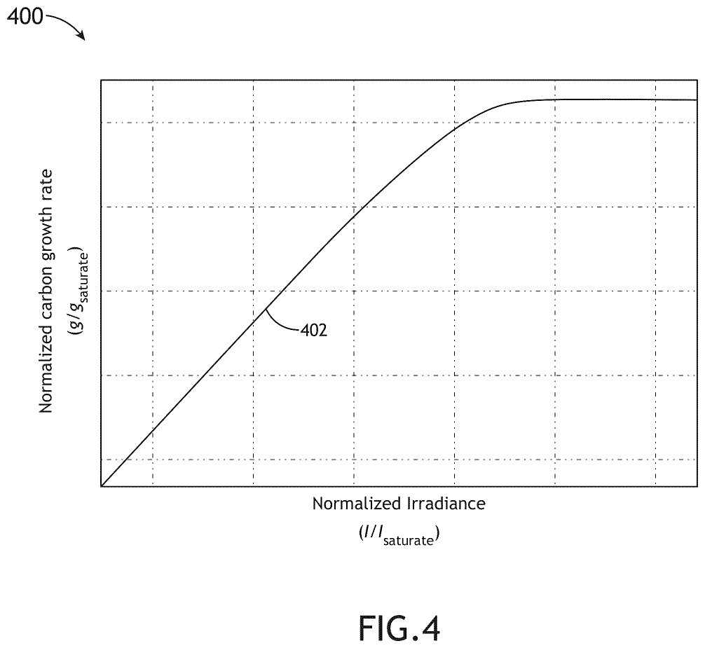

In embodiments, a contaminate growth rate may be any data (e.g., correlated data), knowledge, function, program, or the like. For example, a contaminate growth rate may be a contaminate growth rate curve, function, data table, or the like. For instance, a nonlimiting example of a contaminate growth rate curve 402 is illustrated in plot 400 of FIG. 4. In embodiments, each value of each location of a predicted contaminate distribution 506 is determined by multiplying its respective aggregated irradiance distribution value by a contaminate growth rate (e.g., a carbon growth rate) using the contaminate growth rate curve 402.

The contaminate growth rate is generally a function of the particular wavelength of the irradiance. A challenge of simulating contaminate deposits is that, for a given dose, VUV/UV light disproportionately produces more carbon deposits than EUV light. The effect is so significant, that in EUV optical systems where EUV light dominates in intensity over VUV/UV light, the VUV/UV light may nonetheless cause nonnegligible amounts of carbon deposits. In embodiments, a different contaminate growth rate is used for each wavelength or wavelength range to address this challenge. For example, an aggregated irradiance distribution for each respective wavelength may be separately simulated and each aggregated irradiance distribution may be used with a respective wavelength-specific contaminate growth rate to determine an (overall) predicted contaminate distribution.

For example, the contaminate distributions 506 caused by EUV and VUV/UV light may be considered (e.g., simulated) separately and then combined. However, another challenge is that the amount of VUV/UV light in an EUV optical system 100 may not necessarily be as well understood as the amount of EUV light. In embodiments, the amount of VUV/UV light may be sampled/measured to address such a challenge. For example, the VUV/UV spectral ranges and intensities thereof may be based on a discrete sampling using a light sensor in one or more locations (e.g., any location) of the EUV optical system 100. In this regard, a VUV/UV measurement may be acquired from the EUV optical system 100 and used to simulate a VUV-based contaminate distribution. On the other hand, the EUV spectrum parameters used in a simulation may be more easily determined, such as being determined based on a known illumination beam 120 wavelength and intensity. Note that such EUV and VUV/UV wavelengths and intensities used in a simulation are examples of illumination spectrum parameters.

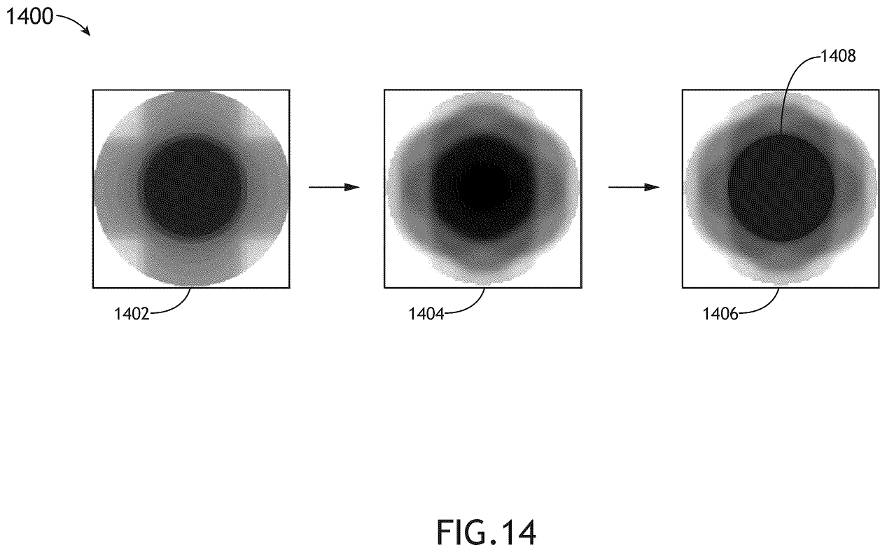

Note that such a sampling of VUV/UV light may also be utilized in a method for separately determining, and combining, VUV/UV and EUV based contaminate growth rate distributions as is described further below in regard to FIG. 14.

In a step 210, a cleaning recipe for a collection optical element 112 is determined based on the predicted contaminate distribution 506. In embodiments, the cleaning recipe is determined by the one or more processors 106 and stored on memory 108. For example, the cleaning recipe may be stored and sent to a cleaning sub-system to perform a cleaning or used by the one or more processors 106 of the EUV optical system 100 to direct a cleaning to be performed. For example, the cleaning recipe may include one or more cleaning processes. For instance, each cleaning process may utilize a respective modulator of one or more modulators, where each respective modulator is configured to selectively direct a respective portion of a cleaning illumination to a respective optical element area of the collection optical element 112.

In embodiments, a cleaning recipe for the collection optical element 112 is determined using any method disclosed herein or known in the art and may be stored or transmitted in any format known in the art. For example, a cleaning recipe may be data used by an automated or semi-automated cleaning program configured to direct one or more elements to perform a cleaning of the collection optical element 112. For instance, the cleaning recipe may be indicative of how much cleaning illumination intensity should be used, for how much time, and/or in which areas should it be applied. Further, for instance, the cleaning recipe may include data configured to be used to fabricate one or more modulators or select a modulator from a generic set of one or more modulators.

In another example, the cleaning recipe may be a transmission configured to cause data to be displayed to a user indicative of information helpful in performing a cleaning of a collection optical element 112. For instance, the cleaning recipe may be data sent to a program configured to cause a graphic to be shown via a graphical user interface on a display to a user. For example, the cleaning recipe may be one or more text and/or symbol graphics indicative of one or more parameters or steps to be performed in a cleaning. For instance, such graphics could be indicative of which modulators to used, how large a cleaning dose to use (e.g., for how much time and what intensity should the cleaning illumination be), and/or for which areas of the collection optical element 112 should the cleaning be performed for.

A modulator may include any modulator configured to selectively direct (e.g., block, filter, reflect, diffract, and the like) a cleaning illumination. For example, a modulator may include an aperture and/or a diffractive optical element (DOE) configured to produce a far-field diffraction pattern.

It is noted that FIGS. 1-14 and descriptions herein are provided merely for illustrative purposes are not to be interpreted as limiting and may vary in accordance with one or more embodiments. For example, two or more modulators may be used for cleaning such as one inner and one outer modulator to selectively direct light (e.g., UV cleaning illumination) to the collection optical element 112. In an additional example, a modulator used for cleaning may be based on a Zernike polynomial, such as by decomposing the contaminate distribution 506 into Zernike polynomial terms and selecting one or more modulators based on the Zernike polynomial terms. Note that such examples are not necessarily mutually exclusive. For example, a method may utilize a combination of discretely measured spectral ranges of light, multiple modulators, and/or selecting a modulator based on decomposed Zernike polynomial terms of a contaminate distribution 506.

Referring to FIGS. 3A-14, embodiments and various components are described in detail.

FIG. 3A illustrates a conceptual illustration of checkerboard photomask design data 300 of a sample 124 as retrieved from a database, in accordance with one or more embodiments of the present disclosure.

FIG. 3B illustrates conceptual illustration of a complex pattern photomask design data 302 of a sample 124 as retrieved from a database, in accordance with one or more embodiments of the present disclosure.

FIG. 4 illustrates a plot 400 of a carbon contaminate growth rate curve 402, in accordance with one or more embodiments of the present disclosure. The growth rate of carbon contamination is generally dependent on the input EUV photon flux until the irradiance reaches the carbon mass limited region, where the carbon growth rate saturates at a value dependent upon a species and partial pressure of the volatile organic contamination (VOC).

FIG. 5A illustrates a schematic of an illumination pupil distribution 500 of a circular (e.g., “flat top”) illumination beam, in accordance with one or more embodiments of the present disclosure.

FIG. 5B illustrates simulated collection pupil irradiance distributions 502 of diffraction orders based on various incidence angle parameter values simulated based on the circular illumination beam of FIG. 5A and the checkerboard photomask design data of FIG. 3A, in accordance with one or more embodiments of the present disclosure.

FIG. 5C illustrates an aggregated irradiance distribution 504 based on the simulated collection pupil irradiance distributions of FIG. 5B, in accordance with one or more embodiments of the present disclosure.

FIG. 5D illustrates a predicted contaminate distribution 506 based on the aggregated irradiance distribution 504 of FIG. 5C, in accordance with one or more embodiments of the present disclosure.

In embodiments, FIGS. 5A-5D illustrate a simplified example of determining the predicted contaminate distribution 506 of FIG. 5D. In such an example, a numerical aperture (NA) of the EUV optical system 100 is between 0.15 and 0.32 and the coherence of the illumination beam 120 is 0.5. The checkerboard photomask design data of FIG. 3A used to determine the predicted contaminate distribution 506 of FIG. 5D includes a patterned contact array having a pitch of 1 um along an X direction, a pitch of 2 um along a Y direction, and a contact size of 0.6 um by 0.6 um. In embodiments, the aggregated irradiance distribution 504 is based on the incoherent addition of the contributions from irradiance distributions 502 of different incidence angles.

For example, in methods, various incidence angle values corresponding to an illumination condition of the EUV optical sub-system 102 may be selected. For each incidence angle, diffraction orders at a plane may be calculated based on design data (e.g., data of patterns of the sample 124 stored on a database). The calculated diffraction orders may be converted to their irradiance distributions 502 on the pupil plane. In embodiments, a thin-mask approximation is utilized (e.g., utilized during the diffraction order calculation), which may allow for relatively efficient computation. In embodiments, diffraction distributions from other incidence angles can be interpolated from such thin-mask approximations relatively accurately. In alternate embodiments, a more rigorous calculation is performed during a database preparation stage configured to process or generate the database data.

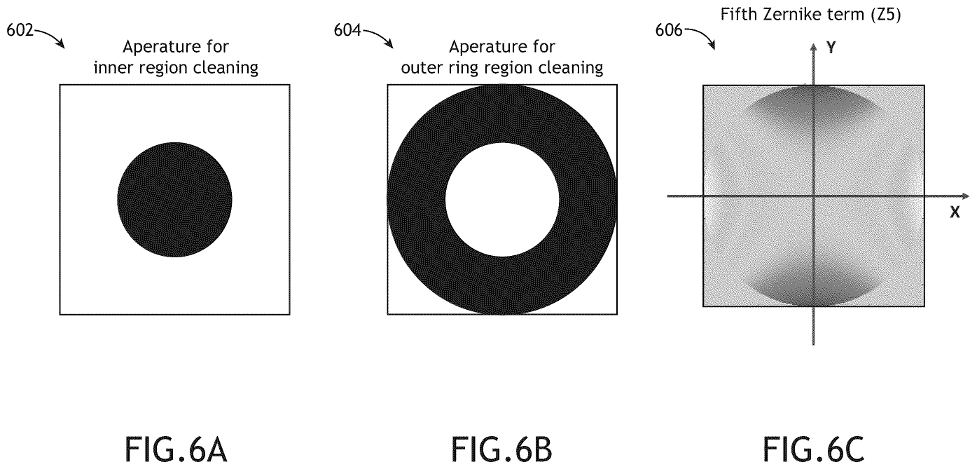

Referring now to FIGS. 6A and 6B, a first modulator 602 and a second modulator 604 are illustrated, in accordance with one or more embodiments of the present disclosure. For example, the first modulator 602 and the second modulator 604 may be used in a two-part cleaning process for uniformly cleaning an inner and outer region. FIG. 6C, on the other hand, illustrates a fifth Zernike term distribution 606, such as may be used as a far-field diffraction pattern of a diffractive optical element (DOE) to provide for non-uniform (e.g., non-binary, varying intensity) cleaning.

In embodiments, referring to FIGS. 6A and 6B, a first modulator 602 of two or more modulators is configured to selectively direct a first portion of a cleaning illumination to an inner region of the collection optical element 112 according to an inner cleaning process, and a second modulator 604 of the two or more modulators may be configured to selectively direct a second portion of the cleaning illumination to an outer region of the collection optical element 112 according to an outer cleaning process.

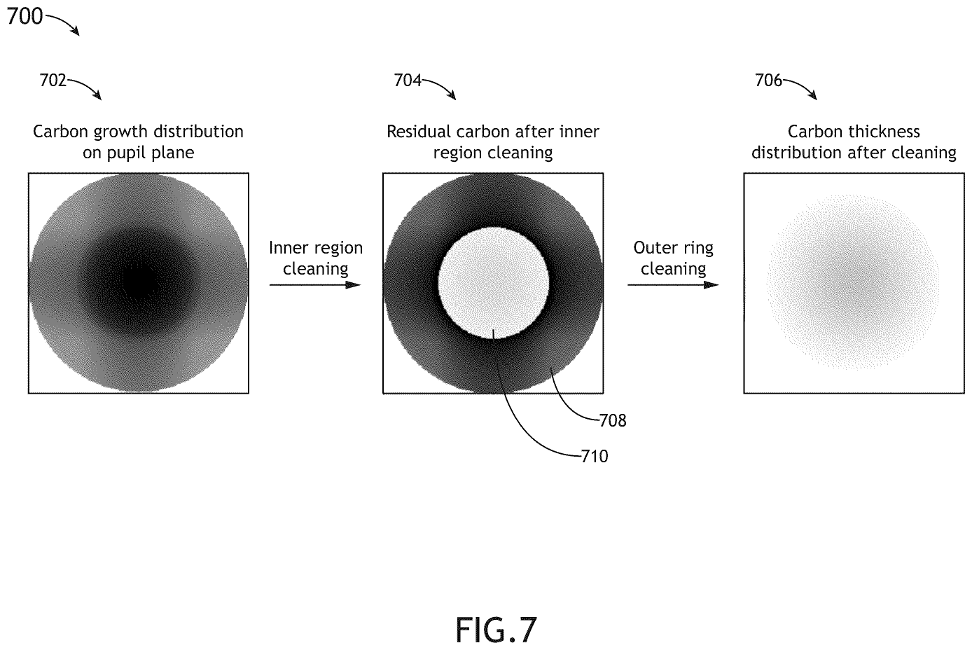

FIG. 6A illustrates a first modulator 602 configured for cleaning an inner region of the collection optical element 112 and FIG. 6B illustrates a second modulator 604 configured for cleaning an outer region of the collection optical element 112. For example, an outer region 708 and inner region 710 are illustrated in FIG. 7. Note that FIGS. 6A-7 are provided merely for illustrative purposes and any number and shape of regions and corresponding modulators may be used such as circular, rectangular, annular, diamond-shaped, radially patterned, and the like.

In embodiments, the cleaning recipe includes two or more cleaning processes configured to utilize two or more modulators. For example, a single DOE located in a light pathway of the UV cleaning illumination may be used to modulate the UV cleaning illumination to be uniform. Further, two apertures (e.g., modulators 602, 604) may be used to direct the uniform UV cleaning illumination to clean the inner region 710 and the outer region 708 of the collection optical element 112. An advantage of embodiments with multiple cleaning processes over traditional methods of cleaning the whole mirror simultaneously is to avoid or minimize overcleaning considering large differences of carbon thickness between different regions.

FIG. 7 illustrates a flow diagram illustrating a method 700 for a two-part cleaning process of a collection optical element 112 as well as views 702, 704, 706 of a carbon distribution on the collection optical element 112, in accordance with one or more embodiments of the present disclosure. A view 702 of carbon distribution on a pupil plane before an inner region cleaning, a view 704 of the carbon distribution after the inner region cleaning, and a view 706 of the carbon distribution after an outer region cleaning are illustrated.

In an optional step, referring back to step 210 of FIG. 2, the determining of the cleaning recipe may include determining an inner cleaning process and outer cleaning process.

For example, the inner cleaning process may include directing a system (e.g., any system or sub-system) to perform a cleaning of the inner region 710 of the collection optical element 112 utilizing the first modulator 602 of FIG. 6A. For instance, inner cleaning process may be a step performed between view 702 and view 704 utilizing the first modulator 602. For instance, the inner region 710 may be an area of the collection optical element 112 associated with a zeroth diffraction order of irradiation. The zeroth diffraction order may dominate over other diffraction orders, causing a large build-up of contaminate, and may, in some examples, be caused by an irradiance that corresponds to a saturated region of a contaminate growth rate curve 402. In some examples, the inner region 710 has a uniform or nearly uniform contaminate distribution.

Further, the outer cleaning process may include directing a system to perform a cleaning of the outer region 708 of the collection optical element 112 utilizing the second modulator 604 of FIG. 6B. For instance, outer cleaning process may be a step performed between view 704 and view 706 utilizing the second modulator 604. For instance, the outer region 708 may be an area of the collection optical element 112 associated with non-zero diffraction orders (e.g., plus and minus first diffraction orders, plus and minus second diffraction orders, and the like) of irradiation.

In embodiments, the inner region 710 may be cleaned multiple times before cleaning the outer region 708 such as when the contaminate distribution 506 in the outer region 708 is considered small enough to require less frequent cleaning.

In embodiments, any type of collection optical element 112 in any location may be simulated and/or cleaned in accordance with one or more embodiments. For example, locations of the collection optical element 112 and/or locations to be simulated may include one or more planes. For instance, a plane of the EUV optical sub-system 102 may be where the collection optical element 112 is located, which may also be the plane from which the irradiance distributions 502 are simulated at. In this regard, the irradiance received by the collection optical element 112 may be simulated. In one example, such a plane includes a pupil plane. In another example, such a plane includes a field plane.

For purposes of the present disclosure, terms such as “pupil” plane, “field” plane, and the like are meant to include locations that are near such planes. For example, “at a pupil plane” generally includes any pupil plane of an EUV optical system, including planes that are near pupil planes. For example, in some instances the exact location of a pupil plane is inaccessible and is located within another optical element or sub-system, and any optical elements that are placed near those locations are still considered to be “at” the pupil plane for purposes of the present disclosure. For example, “at the pupil plane” may mean adjacent to elements of the pupil plane.

In embodiments, the contaminate may be any contaminate with a growth rate. For example, the contaminate may include a carbon-based molecule such as carbon.

In an optional step, a system is directed to perform a cleaning of the collection optical element 112 based on the cleaning recipe. Any system and method may be used to provide for a cleaning of the collection optical element 112. For example, an EUV optical system 100 may itself be configured to clean the collection optical element 112 or a separate system may be used. In embodiments, a cleaning system may utilize a light source configured for providing photon energy (e.g., cleaning illumination) at or slightly higher than the binding energies of contaminants. Furthermore, the photon energy provided by the light source (e.g., illumination source 114 used as a cleaning illumination source or a different source) may be utilized in combination with a mixture of gas to dissociate the contaminants. For instance, the light source may provide extreme ultraviolet (EUV), vacuum ultraviolet (VUV), deep ultraviolet (DUV), ultraviolet (UV), visible light, infrared (IR) or the like to the surface of the collection optical element 112. EUV, VUV or DUV photons in combination with a presence of H₂, N₂, He, Ar, Xe, H2O, O2, O3, CO2 or other gases near the area to be cleaned may form reactive free radicals to dissociate the contaminate. If the contaminate includes multiple contaminate species, using a mixture of gasses may help targeting different contaminate species that need to be cleaned. In embodiments, specific contaminants are targeted by selecting the correct gas (or a combination of gases) to induce the photodissociation. In addition, multiple wavelengths or combinations of EUV, VUV, DUV, UV, Visible, IR or the like may be utilized to create target free radicals from single gas or mixtures of gasses. In this manner, various types of photons provided by the light source in combination with various types of gasses may effectively deliver free radicals that may react with the contaminates and therefore clean the surface of the collection optical element 112. For example, systems and methods for cleaning optical elements using illumination are disclosed in U.S. Pat. No. 9,335,279, issued on May 10, 2016, and U.S. Pat. No. 9,810,991, issued on Nov. 7, 2017, which are each hereby incorporated by reference in their entirety.

For example, the cleaning recipe may be an ultraviolet radiation ozone (UVO) cleaning recipe configured to be used to direct a UV cleaning illumination to the collection optical element 112 in a presence of ozone molecules. For example, the EUV optical system 100 may include a UV source. The UV source may generate a UV cleaning illumination such that the UV cleaning illumination is directed to a collection optical element 112. For example, the UV source may be configured to direct the UV cleaning illumination along the collection pathway 128 at the one or more collection optical elements 112 or along a different pathway (not shown) at the one or more collection optical elements 112. Moreover, the EUV optical sub-system 102 may be configured to receive one or more modulators 602, 604. In addition, EUV optical sub-system 102 may be configured to store the one or more modulators 602, 604 and move the one or more modulators 602, 604 in the path of the UV cleaning illumination via an actuation process. For example, the actuation process may include a modulator translation element (e.g., electrical motor or any other actuating element) to move a modulator 602, 604 into and out of the path of the UV cleaning illumination.

In embodiments, non-uniform cleaning is performed, such as when uniform cleaning is insufficient. For example, DOE modulators of Zernike polynomial terms may be used when performing non-uniform cleaning. In embodiments, a far-field diffraction pattern of a DOE may be designed/selected such that various areas of the collection optical element 112 receive cleaning in proportion to the amount of contaminate thereon. For example, the contaminate distribution 506 may be decomposed into one or more Zernike terms to produce one or more Zernike-polynomial-based distributions. Further, a far-field diffraction pattern of the DOE may be associated with (e.g., selected based on, designed for, or the like) the one or more Zernike-polynomial-based distributions. For example, the contaminate distribution 506 may be dominated by low-order Zernike polynomial terms such as first order and second order terms. The DOE modulators may be based on one or more of these low order Zernike polynomial terms to minimize the number of modulators needed. In embodiments, a generic set of DOE modulators of each low-order Zernike polynomial term may be stored in inventory to allow for a quick selection of modulators to be used for cleaning. FIG. 6C illustrates a fifth Zernike term distribution 606, such as may be used as a far-field diffraction pattern of a diffractive optical element (DOE) to provide for non-uniform (i.e., non-binary, varying) cleaning.

Zernike polynomial terms may be determined using any method known in the art or disclosed herein. For example, the carbon thickness distribution (t) in the pupil plane may be defined as t(k), where k is the pupil position. Typically, a reduction in performance (e.g., reduction in clarity, reflectivity, and the like) due to a distribution of contaminates is dominated by the low-order Zernike terms such as first order and second order terms. We can decompose a distribution function (i.e., W(k)) into a few leading order Zernike polynomial terms as follows:

t(\vec{k})=Σᵢ₌₁⁹CᵢZᵢ(\vec{k}) (Equation 1)
where Z₅(\vec{k}), for example, is the fifth Zernike polynomial term.

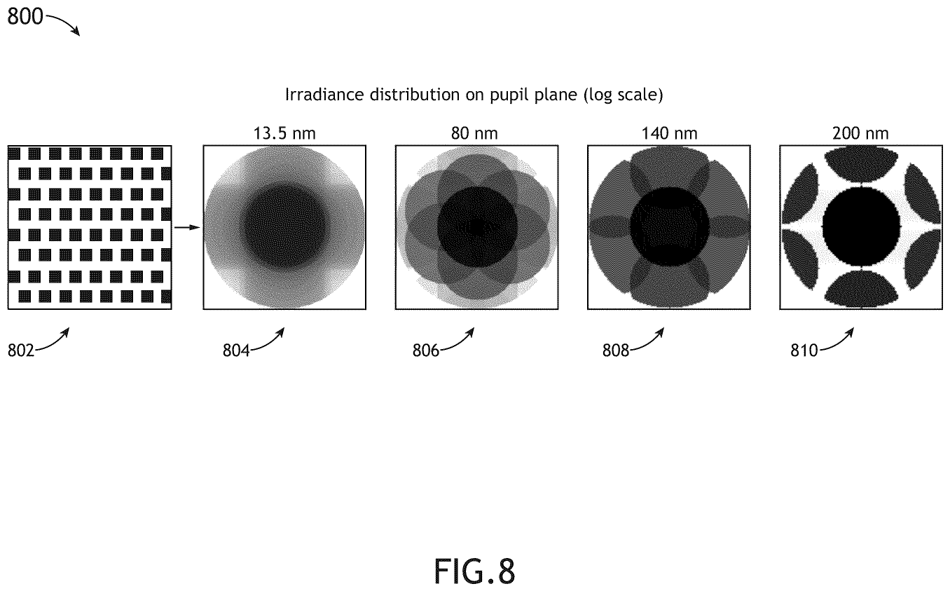

FIG. 8 illustrates a flow diagram 800 of irradiance distributions 804, 806, 808, 810 for different wavelengths (e.g., 13.5 nm, 80 nm, 140 nm, and 200 nm) of light based on a dense pattern of design data 802, in accordance with one or more embodiments of the present disclosure. For example, the EUV spectral range of light includes 13.5 nm light. Such wavelength-specific irradiance distributions may be separately calculated and used to separately calculate carbon growth rate distributions and/or carbon distributions.

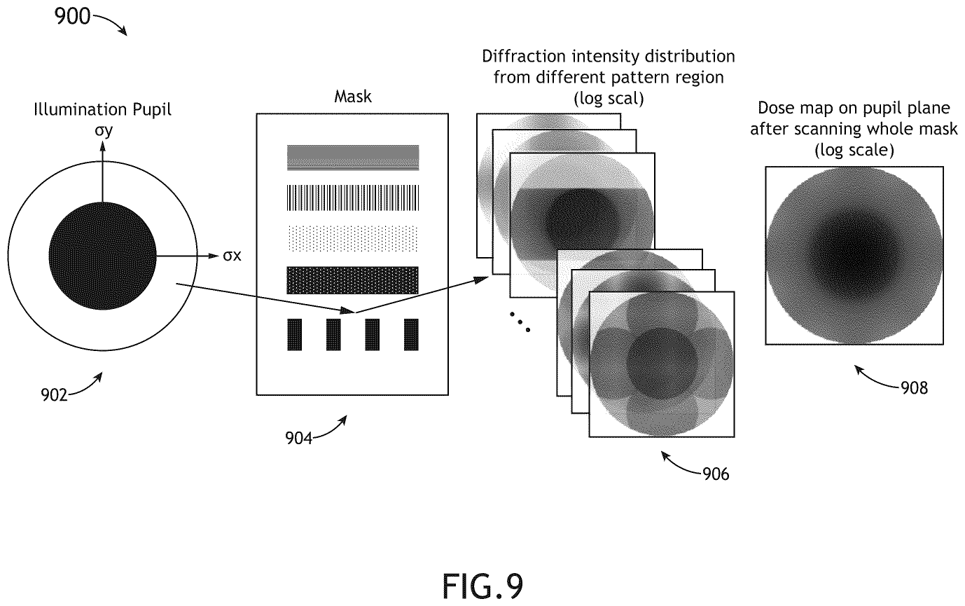

FIG. 9 illustrates a flow diagram 900 illustrating irradiance distributions 906 for different patterns of design data 904 of a single sample 124 based on an illumination pupil distribution 902, in accordance with one or more embodiments of the present disclosure. In embodiments, the irradiance distributions 906 are different for different patterns. However, when combining irradiance distributions 906 for different patterns—such as may occur when scanning a variety of samples and patterns—the aggregated irradiance distribution 908 may be more radially uniform but still have an inner portion dominated by a zeroth diffraction order. In this regard, generally, the more varied the patterns are and the more patterns are aggregated, the more radially uniform an inner and outer region may be.

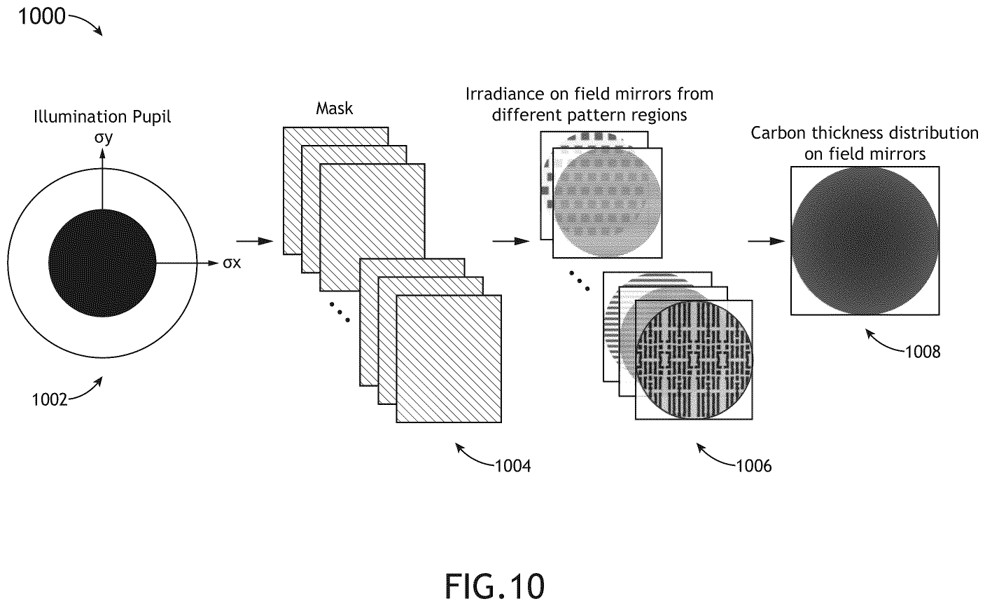

FIG. 10 illustrates a flow diagram 1000 illustrating irradiance distributions 1006 in a field plane for different patterns (not shown) for a circular illumination beam 1002 imaging multiple samples 1004, in accordance with one or more embodiments of the present disclosure. In embodiments, a carbon distribution 1008 of a mirror located in the field plane may be determined. In embodiments, a carbon distribution 1008 of a field plane, rather than a pupil plane, may be more likely to be relatively uniform due to a lack of diffraction order consistency, although some variation may still exist. In embodiments, one or more DOE modulators may be used to perform a cleaning of a collection optical element 112 located in a field plane.

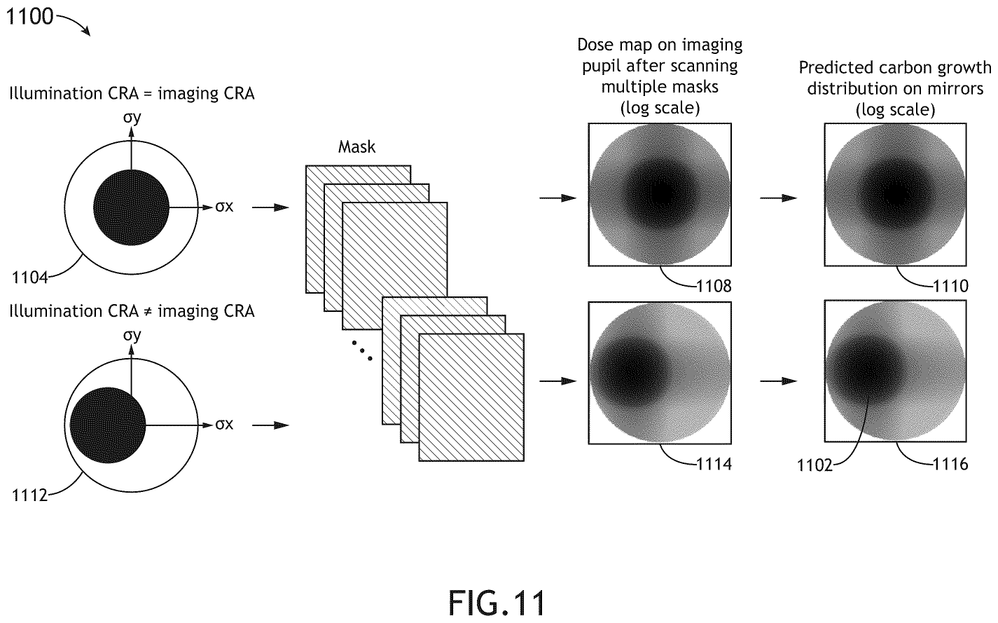

FIG. 11 illustrates a flow diagram 1100 of carbon distributions 1110, 1116 simulated with and without an illumination chief-ray angle (CRA) equal to an imaging CRA, in accordance with one or more embodiments of the present disclosure. Carbon distribution 1110 is based on an aggregated irradiance distribution 1108 simulated with the illumination CRA equal to the imaging CRA. Carbon distribution 1116 is based on an aggregated irradiance distribution 1114 simulated with the illumination CRA not equal to the imaging CRA.

In general, the location of higher than zeroth diffraction orders (e.g., first order diffraction orders) of mask patterns on a pupil plane depend on the shape and layout of patterns under inspection, but the location of all diffraction orders may depend on other parameters such as illumination CRA and imaging CRA. In embodiments, a regular photomask contains simple and/or complex patterns with different pitches and orientations. Thus, after inspecting multiple masks, an aggregated dose of higher than zeroth diffraction orders in the pupil plane may be blurred out (e.g., more uniform), while the aggregated dose of zeroth diffraction order continues to increase as more masks are imaged. In addition, an irradiance intensity of the zeroth diffraction order is in general larger than an irradiance intensity of higher diffraction orders. Consequently, an aggregated irradiance distribution of a pupil plane after scanning multiple masks may be dominated by the zeroth order region. For example, an EUV inspection system with a numerical aperture (NA) between 0.15 and 0.32, using a flat-top illumination source as shown by illumination beam 1104 with coherence σ=0.5, may be used to scan multiple masks. In such an example, if the illumination chief-ray angle (CRA) is equal to the imaging CRA, assuming they are both 6°, the aggregated irradiance distribution (i.e., dose map) on the pupil plane may concentrate in the zeroth diffraction order region around the pupil center. For example, such a concentration may be shown by the darker center portion of the aggregated irradiance distribution 1108. In another example, the illumination CRA may deviate from the imaging CRA, as shown by illumination beam 1112, such as when the illumination CRA is 1° and the imaging CRA is 6°. In such an example, the carbon thickness distribution may shift from the pupil center as shown by dense contaminate region 1102 of the carbon distribution 1116.

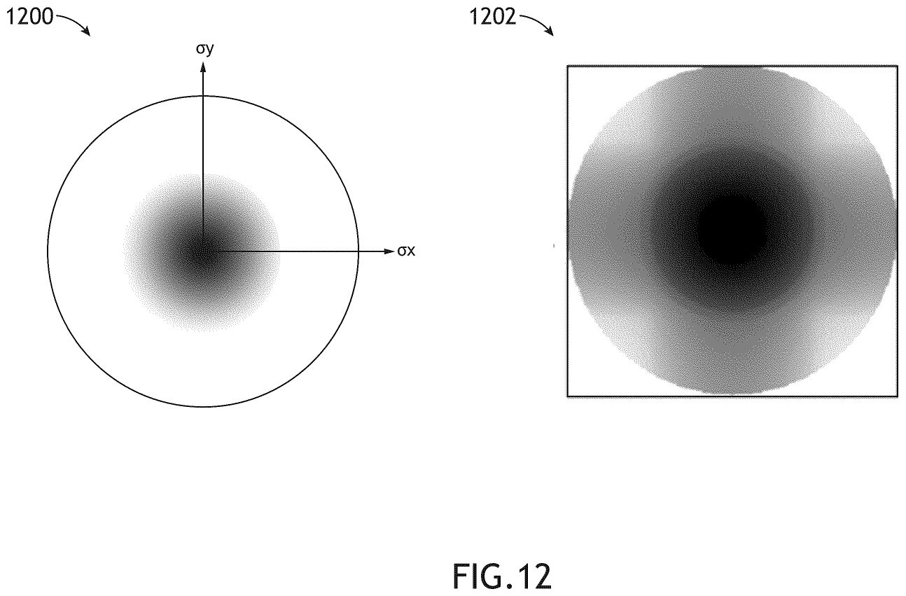

FIG. 12 illustrates a gaussian-shaped illumination beam 1200 and a contaminate distribution 1202 based on the gaussian-shaped illumination beam 1200, in accordance with one or more embodiments of the present disclosure.

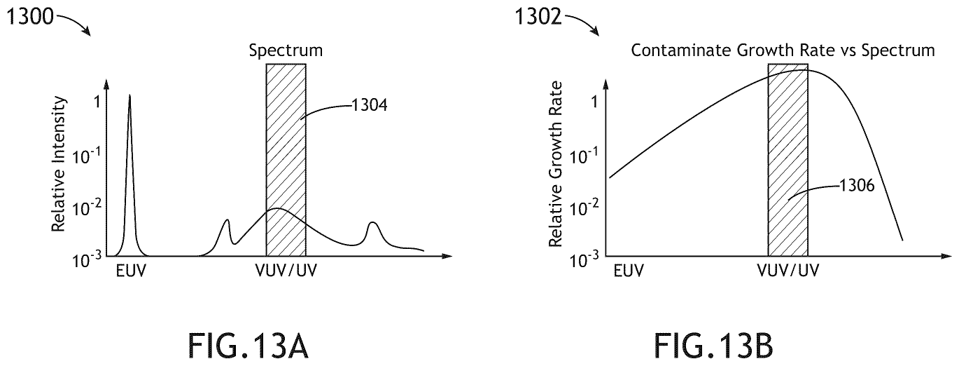

FIG. 13A illustrates a plot 1300 of a normalized intensity of light of an EUV optical system 100, in accordance with one or more embodiments of the present disclosure. As shown, the amount of EUV dominates over the peak intensity of VUV/UV light 1304.

FIG. 13B illustrates a plot 1302 of a normalized contaminate growth rate versus spectrum of light for a given intensity of irradiance, in accordance with one or more embodiments of the present disclosure. As shown, VUV/UV spectral ranges of light 1306, for a given intensity, produce more contaminate deposits than some other spectral ranges of light.

FIG. 14 illustrates a flow diagram of a process 1400 for determining a carbon growth rate distribution 1406 based on EUV and VUV/UV light, in accordance with one or more embodiments of the present disclosure.

In embodiments, referring back to FIGS. 13A, 13B, and 14, irradiance distributions may be calculated for specific wavelengths and used to determine contaminate growth rate distributions indicative of the contaminate growth rate at all locations across the surface of the collection optical element 112. Such contaminate growth rate distributions may be combined to get an overall contaminate growth rate distribution. Such an overall contaminate growth rate distribution may be utilized in accordance with one or more embodiments herein, such as used to determine the predicted contaminate distribution. For example, the intensity of a spectrum of light obtained from FIG. 13A may be combined with (e.g., multiplied with, integrated with, and the like) a corresponding contaminate growth rate in FIG. 13B to generate a carbon growth rate distribution for a specific wavelength. For example, an EUV carbon growth rate distribution 1402 may be generated based on the EUV spectrum of light. Next, for example, a combined carbon growth rate distribution 1404 may be determined by combining the EUV carbon growth rate distribution 1402 with a VUV/UV carbon growth rate distribution (not shown). In addition, for example, an adjusted carbon growth rate distribution 1406 may be determined by checking and adjusting the combined carbon growth rate distribution 1404 for portions/values that reach and/or exceed a saturation threshold. For example, referring back to FIG. 4, a contaminate growth rate may reach a point of saturation, such as a mass limited region, where further increases in irradiance do not result in increases in contaminate growth rate. For instance, saturated region 1408 may be adjusted/changed to be equal to a saturated (i.e., maximum) contaminate growth rate value based on a saturation threshold.

Referring again to FIG. 1, embodiments and various components are described in additional detail.

In embodiments, the EUV optical sub-system 102 is configured to capture a measurement beam 122 through a collection pathway 128. The measurement beam 122 is defined as light reflected or diffracted from the sample 124 and passing through a collection pathway 128 of the EUV optical sub-system 102 such that at least a portion of which may be measured (e.g., imaged) by detector 116.

The measurement beam 122 may include an irradiance distribution of diffraction orders received at or near a pupil plane of the EUV optical sub-system 102 by a collection optical element 112.

In embodiments, the EUV optical system 100 includes an EUV optical sub-system 102. The EUV optical system 100 may include any number of EUV optical sub-systems 102 and each EUV optical sub-system 102 may include any number of sub-systems (e.g., metrology and/or inspection sub-systems). For example, the EUV optical sub-system 102 may be configured to operate in the EUV spectral range of light.

As noted previously herein, the EUV optical sub-system 102 may include a detector 116. For example, the detector 116 may be a multi-pixel detector. For instance, the detector 116 may be located at a field plane 118 conjugate to the object plane of the sample 124.

As noted previously herein, the one or more processors 106 of the controller 104 may be communicatively coupled to memory 108, where the one or more processors 106 may be configured to execute a set of program instructions maintained in memory 108, and the set of program instructions may be configured to cause the one or more processors 106 to carry out various functions and steps of the present disclosure.

It is noted herein that the one or more components of EUV optical system 100 may be communicatively coupled to the various other components of EUV optical system 100 in any manner known in the art. For example, the one or more processors 106 may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller 104 may be communicatively coupled to one or more components of EUV optical system 100 via any wireline or wireless connection known in the art.

In embodiments, the one or more processors 106 may include any one or more processing elements known in the art. In this sense, the one or more processors 106 may include any microprocessor-type device configured to execute software algorithms and/or instructions. In embodiments, the one or more processors 106 may consist of a desktop computer, mainframe computer system, workstation, image computer, parallel processor, or other computer system (e.g., networked computer) configured to execute a program configured to operate the EUV optical system 100, as described throughout the present disclosure. It should be recognized that the steps described throughout the present disclosure may be carried out by a single computer system or, alternatively, multiple computer systems. Furthermore, it should be recognized that the steps described throughout the present disclosure may be carried out on any one or more of the one or more processors 106. In general, the term “processor” may be broadly defined to encompass any device having one or more processing elements, which execute program instructions from memory 108. Moreover, different subsystems of the EUV optical system 100 (e.g., EUV optical sub-system 102, controller 104, user interface, and the like) may include processor or logic elements suitable for carrying out at least a portion of the steps described throughout the present disclosure. Therefore, the above description should not be interpreted as a limitation on the present disclosure but merely an illustration.

The memory 108 may include any storage medium known in the art suitable for storing program instructions executable by the associated one or more processors 106 and the data received from the EUV optical system 100. For example, the memory 108 may include a non-transitory memory medium. For instance, the memory 108 may include, but is not limited to, a read-only memory (ROM), a random-access memory (RAM), a magnetic or optical memory (e.g., disk), a magnetic tape, a solid-state drive and the like. It is further noted that the memory 108 may be housed in a common controller housing with the one or more processors 106. In an alternative embodiment, the memory 108 may be located remotely with respect to the physical location of the processors 106, controller 104, and the like. In another embodiment, the memory 108 maintains program instructions for causing the one or more processors 106 to carry out the various steps described through the present disclosure.

In embodiments, the user interface is communicatively coupled to the controller 104. The user interface may include, but is not limited to, one or more desktops, tablets, smartphones, smart watches, or the like. In another embodiment, the user interface includes a display used to display data of the EUV optical system 100 to a user. The display of the user interface may include any display known in the art. For example, the display may include, but is not limited to, a liquid crystal display (LCD), an organic light-emitting diode (OLED) based display, or a CRT display. Those skilled in the art should recognize that any display device capable of integration with a user interface is suitable for implementation in the present disclosure. In another embodiment, a user may input selections and/or instructions responsive to data displayed to the user via a user input device of the user interface.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” “downward”, “X direction” and the like are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An EUV optical system comprising:
an EUV optical sub-system comprising:
an illumination source configured to generate an illumination beam; and
one or more optical elements configured to reflect a measurement beam, wherein the one or more optical elements are located in a collection pathway of the EUV optical sub-system; and
a controller communicatively coupled to the EUV optical sub-system, the controller including one or more processors configured to execute program instructions causing the one or more processors to:
receive design data of one or more samples;
simulate a plurality of irradiance distributions at a plane of the EUV optical sub-system based on the design data and one or more parameters;
aggregate the plurality of irradiance distributions to generate an aggregated irradiance distribution;
determine a predicted contaminate distribution based on both the aggregated irradiance distribution and a contaminate growth rate, wherein the contaminate distribution is indicative of a predicted amount of contaminate deposited on the one or more optical elements; and
determine a cleaning recipe for the one or more optical elements based on the predicted contaminate distribution, wherein the cleaning recipe comprises one or more cleaning processes.

2. The EUV optical system of claim 1, wherein the plane of the EUV optical sub-system comprises a pupil plane.

3. The EUV optical system of claim 1, wherein the plane of the EUV optical sub-system comprises a field plane.

4. The EUV optical system of claim 1, wherein the contaminate deposited on the one or more optical elements comprises carbon.

5. The EUV optical system of claim 1, wherein the cleaning recipe comprises an ultraviolet radiation ozone (UVO) cleaning recipe configured to direct UV illumination to the one or more optical elements in presence of ozone molecules.

6. The EUV optical system of claim 1, wherein each cleaning process utilizes a respective modulator of one or more modulators, wherein each respective modulator is configured to selectively direct a respective portion of a cleaning illumination to a respective optical element area of the one or more optical elements.

7. The EUV optical system of claim 6, wherein the one or more modulators comprises a diffractive optical element (DOE) configured to produce a far-field diffraction pattern.

8. The EUV optical system of claim 7, wherein the far-field diffraction pattern is based on one or more Zernike polynomials.

9. The EUV optical system of claim 6, wherein the one or more modulators comprise a modulator based on one or more Zernike polynomials.

10. The EUV optical system of claim 6, wherein the cleaning recipe comprises two or more cleaning processes utilizing two or more modulators.

11. The EUV optical system of claim 10, wherein a first modulator of the two or more modulators is configured to selectively direct a first portion of the cleaning illumination to an inner region of the one or more optical elements according to an inner cleaning process, and a second modulator of the two or more modulators is configured to selectively direct a second portion of the cleaning illumination to an outer region of the one or more optical elements according to an outer cleaning process.

12. The EUV optical system of claim 11, wherein the inner region comprises a circular region.

13. The EUV optical system of claim 11, wherein the outer region comprises an annular region.

14. The EUV optical system of claim 1, wherein the determining the cleaning recipe comprises decomposing the contaminate distribution into one or more Zernike-polynomial-based distributions.

15. The EUV optical system of claim 1, wherein the aggregated irradiance distribution comprises an aggregated extreme ultraviolet radiation (EUV) irradiance distribution corresponding to a simulated scan across the one or more samples.

16. The EUV optical system of claim 1, wherein the one or more parameters comprise multiple incidence angles of an optical axis of the EUV optical system.

17. The EUV optical system of claim 1, wherein the one or more parameters comprise illumination spectrum parameters based on a spectral range of light of the illumination beam.

18. The EUV optical system of claim 17, wherein the illumination spectrum parameters are further based on a vacuum-ultraviolet/ultraviolet (VUV/UV) measurement acquired from the EUV optical system.

19. The EUV optical system of claim 1, wherein the EUV optical system is configured to operate in an extreme ultraviolet radiation (EUV) spectral range of light.

20. The EUV optical system of claim 1, wherein the one or more samples comprise one or more photomasks.

21. The EUV optical system of claim 1, wherein the one or more processors are further configured to cause the one or more processors to:
direct a system to perform a cleaning of the one or more optical elements based on the cleaning recipe.

22. The EUV optical system of claim 1, wherein the EUV optical system includes an EUV lithography system.

23. A method comprising:
receiving design data of one or more samples;
simulating a plurality of irradiance distributions at a plane of an EUV optical sub-system based on the design data and one or more parameters;
aggregating the plurality of irradiance distributions to generate an aggregated irradiance distribution;
determining a predicted contaminate distribution based on both the aggregated irradiance distribution and a contaminate growth rate, wherein the contaminate distribution is indicative of a predicted amount of contaminate deposited on one or more optical elements of the EUV optical sub-system; and
determining a cleaning recipe for the one or more optical elements based on the predicted contaminate distribution, wherein the cleaning recipe comprises one or more cleaning processes,
wherein the EUV optical sub-system comprises an illumination source configured to generate an illumination beam; and the one or more optical elements configured to reflect a measurement beam, wherein the one or more optical elements are located in a collection pathway of the EUV optical sub-system, wherein an EUV optical system comprises the EUV optical sub-system.

24. The method of claim 23, wherein the plane of the EUV optical sub-system comprises a pupil plane.

25. The method of claim 23, wherein the plane of the EUV optical sub-system comprises a field plane.

26. The method of claim 23, wherein the contaminate deposited on the one or more optical elements comprises carbon.

27. The method of claim 23, wherein the cleaning recipe comprises an ultraviolet radiation ozone (UVO) cleaning recipe configured to direct UV illumination to the one or more optical elements in presence of ozone molecules.

28. The method of claim 23, wherein each cleaning process utilizes a respective modulator of one or more modulators, wherein each respective modulator is configured to selectively direct a respective portion of a cleaning illumination to a respective optical element area of the one or more optical elements.

29. The method of claim 28, wherein the one or more modulators comprises a diffractive optical element (DOE) configured to produce a far-field diffraction pattern.

30. The method of claim 29, wherein the far-field diffraction pattern is based on one or more Zernike polynomials.

31. The method of claim 28, wherein the one or more modulators comprise a modulator based on one or more Zernike polynomials.

32. The method of claim 28, wherein the cleaning recipe comprises two or more cleaning processes utilizing two or more modulators.

33. The method of claim 32, wherein a first modulator of the two or more modulators is configured to selectively direct a first portion of the cleaning illumination to an inner region of the one or more optical elements according to an inner cleaning process, and a second modulator of the two or more modulators is configured to selectively direct a second portion of the cleaning illumination to an outer region of the one or more optical elements according to an outer cleaning process.

34. The method of claim 33, wherein the inner region comprises a circular region.

35. The method of claim 33, wherein the outer region comprises an annular region.

36. The method of claim 23, wherein the determining the cleaning recipe comprises decomposing the contaminate distribution into one or more Zernike-polynomial-based distributions.

37. The method of claim 23, wherein the aggregated irradiance distribution comprises an aggregated extreme ultraviolet radiation (EUV) irradiance distribution corresponding to a simulated scan across the one or more samples.

38. The method of claim 23, wherein the one or more parameters comprise multiple incidence angles of an optical axis of the EUV optical sub-system.

39. The method of claim 23, wherein the one or more parameters comprise illumination spectrum parameters based on a spectral range of light of the illumination beam.

40. The method of claim 39, wherein the illumination spectrum parameters are further based on a vacuum-ultraviolet/ultraviolet (VUV/UV) measurement acquired from the EUV optical sub-system.

41. The method of claim 23, wherein the EUV optical sub-system is configured to operate in an extreme ultraviolet radiation (EUV) spectral range of light.

42. The method of claim 23, wherein the one or more samples comprise one or more photomasks.

43. The method of claim 23 further comprising:
cleaning the one or more optical elements based on the cleaning recipe.

44. The EUV optical system of claim 1, wherein the EUV optical system includes an EUV lithography system.
